(19) United States
(12) Patent Application Publication
(10) Pub. No.: US 2025/0291033 A1
(43) Pub. Date: Sep. 18, 2025

(54) METHOD FOR DETECTING OBJECTS FROM POINT CLOUD DATA USING A TRANSFORMER WITH ATTENTION MODEL

(71) Applicant: Robert Bosch GmbH, Stuttgart (DE)

(72) Inventors: Felicia Ruppel, Renningen (DE); Florian Faion, Staufen (DE)

(21) Appl. No.: 18/860,382

(22) PCT Filed: Sep. 12, 2023
(86) PCT No.: PCT/EP2023/074993

§ 371 Date: Oct. 25, 2024

(30) Foreign Application Priority Data
Sep. 28, 2022 (DE) 10 2022 210 248.7

(51) Int. Cl. G01S 7/48; G01S 17/89; G06T 7/73

(52) U.S. Cl. CPC G01S 7/4802; G01S 17/89; G06T 7/73; G06T 2207/10028; G06T 2207/20084; G06T 2207/30261

(57) ABSTRACT

The invention relates to a method for detecting multiple objects (O₁, O₂) from point cloud data using a transformer with attention model, wherein the state of the tracked objects (O₁, O₂) is stored in a feature space. The following steps are carried out:
a. calculating feature vectors from the point cloud data by means of a backbone (2), wherein the feature vectors serve as key vectors (kᵢ) and value vectors (νᵢ) for the transformer;
b. calculating first anchor positions (ρᵢ⁽⁰⁾) for a first layer (s₀) of the transformer from the point cloud data using a sampling method (4);
c. ascertaining feature vectors from the first anchor positions (ρᵢ⁽⁰⁾) using an encoding (5), wherein the feature vectors serve as object queries (γᵢ⁽⁰⁾) for the first layer (s₀) of the transformer;
d. ascertaining result feature vectors (z₁⁽⁰⁾) in the first layer (s₀) of the transformer from the object queries (γᵢ⁽⁰⁾) and the key vectors (kᵢ) and value vectors (νᵢ) using the first layer (s₀) of a decoder (6) of the transformer;
e. calculating (7) box parameters (b_{|z}_{ᵢ}_{⁽⁰⁾}_{|}) for the result feature vectors (zᵢ⁽⁰⁾) of the first layer (s₀) of the transformer;
f. adapting (40, 140) the anchor positions (ρᵢ^{(s)}) for at least one further layer (s) of the transformer by adding the position differences of the box parameters

$$( {b}_{[ {z}_{i}^{( 0 )} ]} )$$

to the first anchor positions (ρᵢ⁽⁰⁾);
g. ascertaining feature vectors from the adapted anchor positions (ρᵢ^{(s)}) using an encoding (50, 150), wherein the feature vectors serve as object queries (γᵢ^{(s)}) for the at least one further layer (s) of the transformer;
h. transforming (90) the result feature vectors (zᵢ⁽⁰⁾) of the first layer with respect to the adapted anchor positions (ρᵢ^{(l)}), wherein the transformed result feature vectors (\tilde{z}ᵢ⁽⁰⁾) serve as object queries for the at least one further layer (s) of the transformer;
i. ascertaining result feature vectors (zᵢ^{(s)}) in the at least one further layer (s) of the transformer from the transformed result feature vectors (\tilde{z}ᵢ⁽⁰⁾) of the previous layer (s₀), the calculated object queries γᵢ^{(s)} of the current layer (s), and the key vectors (kᵢ) and value vectors (νᵢ) using the decoder (60) of the transformer.

The present invention relates to a method for detecting multiple objects from point cloud data using a transformer with attention model.

### PRIOR ART

Object detection nowadays is carried out in imaging sensors. The recorded surroundings typically contain multiple objects and therefore a detection of multiple objects is carried out. Object detection is used in sensors for vehicles, for example, to identify other vehicles, other road users and the infrastructure. These data can be used for (partially) automated or autonomous driving.

Recently, the concept of using transformers for object detection is being pursued. Transformers are described in the paper Ashish Vaswani et al, “Attention is all you need”, arXiv preprint arXiv:1706.03762, 2017, initially in the context of language processing. In object detection, bounding boxes and their box parameters that describe the object, e.g. its position, dimensions, orientation, speed and/or class identifier, are ascertained for each object from a measurement. The transformers can also be used for downstream applications, such as object tracking, prediction or (path) planning. When using transformers for object detection, the suppression of overlapping detections traditionally used in post-processing can be neglected. Until now, these types of transformers have, for instance, been applied to image data. The use on large point clouds, such as those found in the context of autonomous and automated driving, is not known, however.

### DISCLOSURE OF THE INVENTION

The invention relates to a method for detecting multiple objects from point cloud data using a transformer with attention model. The point cloud data are acquired by means of LiDAR, for example. However, this method is not limited to LiDAR; other types of sensors can be used as well. The sensor or sensor system is preferably disposed on a vehicle, so that the point cloud data are collected from the vehicle.

The method comprises the following steps: To start, feature vectors are calculated from the point cloud data. This is not done by the encoder of the transformer as usual, but by a backbone. A backbone is a neural network that is used to extract features from measured data or bring the input into a specific feature representation that can then be further processed. There is therefore no need for the encoder of the transformer. The output of the backbone is preferably reformatted in order to obtain a sequence of feature vectors with a specifiable length. By using the backbone to calculate the feature vectors, the input sequence for self-attention is less limited than with an encoder of the transformer and instead, in the case of a grid-based backbone, such as PointPillars, a sufficiently small cell size can be selected. The thus calculated feature vectors are then fed to the transformer and serve as key vectors and value vectors for ascertaining the cross-attention.

In addition, first anchor positions for a first layer of the transformer are calculated from the point cloud data using a sampling method such as farthest point sampling (FPS). Feature vectors are ascertained from the first anchor positions by means of encoding, for example Fourier encoding. The encoding can in particular be completed by a feed-forward network. The thus calculated feature vectors serve as object queries for the first layer of a decoder of the transformer. The object queries of the anchor positions serve as starting points for the search for objects. The search is not limited to these anchor positions, however; objects at a distance from these anchor positions are detected as well. Anchor positions do not correspond to anchor boxes as are used in other detection approaches. The object queries for the transformer are thus dependent on data and not learned as is typically the case. This is advantageous in particular for sparsely populated point clouds, because otherwise a lot of computing resources are wasted on locating positions that actually have data. Such sparsely populated point clouds are common in particular in measurements with LiDAR. The object queries ascertained from the anchor positions serve as slots for possible objects.

In a first layer, a decoder of the transformer ascertains result feature vectors, which are also referred to as decoder-output vectors, from the object queries, i.e. the above-described feature vectors, and the key vectors and value vectors, i.e. the above-described feature vectors.

Box parameters for bounding boxes that describe an object, e.g. its position or position differences relative to the anchor positions, dimensions, orientation, speed and/or class identifier, are calculated from the result feature vectors using a feed-forward network. For this purpose, a different feed-forward network than the aforementioned feed-forward network which differs in terms of weighting is preferably used to ascertain the object queries.

For the processing of at least one further layer of the transformer, the anchor positions are then adapted using the ascertained box parameters. When adapting the anchor positions, the position differences of the box parameters calculated from the result feature vectors of the first layer of the transformer are added to the first anchor positions. For the result feature vectors of the first layer, box parameters can generally be obtained that are far away from the first anchor position and thus have high position differences. Adapting the anchor positions produces adapted anchor positions that are closer to the actual object. Using an encoding as described above, feature vectors that serve as object queries for the at least one further layer of the transformer are ascertained from the adapted anchor positions.

In order to also propagate the information of the high-dimensional result feature vectors of the first layer in addition to the adapted anchor positions, a transformation of the result feature vectors of the first layer with respect to the adapted anchor positions is carried out. The result feature vectors are aligned with the adapted anchor positions. This is advantageously achieved using a feed-forward network consisting of two layers with a ReLU (rectified linear unit) activation. This requires little additional effort, because only one feed-forward network with two layers is used here.

The above-described steps of adapting the anchor positions, ascertaining the feature vectors from the adapted anchor positions and transforming the result feature vectors are referred to here as refining the object queries.

The transformed result feature vectors and the calculated object queries, in particular their vector sum, are now fed to the decoder of the transformer as input for at least one further layer and serve there as slots for possible objects. In the at least one further layer, the decoder of the transformer ascertains result feature vectors from the transformed result feature vectors ascertained for the previous layer, from the calculated object queries ascertained as described above from the adapted anchor positions, and from the key vectors and value vectors described at the beginning.

As a result, the feature vectors of the at least one further layer and thus also the bounding boxes and lastly the objects ascertained in the at least one further layer are ascertained depending on the refined object queries of the adapted anchor positions of the first layer. The position of the refined object queries is typically closer to the actual object than the position of the original object queries. It can be said that the distance between the position of the object queries from which the acquisition is carried out and the actual object affects the accuracy of the acquisition in the respective layer. Adapting the position of the refined object queries to the previous box parameters reduces the distance between the position of the (refined) object queries and the actual object, so that a more accurate acquisition is achieved.

Transforming the result feature vectors with respect to the adapted anchor positions enables their continued use as object queries for evaluation in subsequent layers. The shape of the result feature vectors is not changed, so known types of encoding can be used. The transformation can be carried out with little additional effort, in particular if a feed-forward network as described above with only two layers is used. Also, the same encoding of the anchor positions as for the first layer is used, so that there is no need to use additional parameters.

The result feature vectors are moreover position-bound vectors, which, in the course of processing by the decoder and being adapted to the anchor positions, gradually obtain more information about the object. The object information is encoded in the latent feature space and not, as is customary, only in the low-dimensional box parameters. In a further step, such vectors can then be propagated in time and, for instance, used for object tracking and prediction. The transformer can therefore be used for other downstream applications that require object detection and work with large point clouds.

Particularly in the first refinement of the object queries, a significant reduction in the distance is achieved, so that a refinement of the object queries only between the first and the second layer of the transformer already has a big impact. The steps of calculating box parameters for the result feature vectors, adapting the anchor positions, ascertaining feature vectors from the adapted anchor positions using an encoding and transforming the result feature vectors with respect to the adapted anchor positions are preferably carried out for at least one further layer of the transformer other than the first layer, in which case the further layer is used in the aforementioned steps instead of the first layer.

The term “first layer” is intended here to be understood as the first layer of the transformer for which the method is used. While it is advantageous to apply the method directly to the first layer of the transformer, it is also conceivable to apply the method to subsequent layers first. In that case, this subsequent layer is interpreted to be the “first” layer.

To train the transformer or the model of the transformer, the following steps are preferably carried out: Multiple sets of box parameters-preferably as many sets of box parameters as object queries are provided at the input of the decoder—are ascertained for the decoder output of each layer. Box parameters of the ground truth, which are assigned to the closest estimated box parameters, are provided as well. The Hungarian method is preferably used for this. Box parameters that do not match are assigned to the “non-object” class and discarded. A median regression, also referred to as [symbol] ₁-loss, is applied to the deviation between the box parameters of the ground truth and the associated estimated box parameters. The transformer is then trained using the median regression.

The transformation of the result feature vectors with respect to the adapted anchor positions, in particular using the feed-forward network as described above, can be trained independent of the transformer or model and then used with fixed weighting. The input data for the transformation and the ground truth are ascertained by a trained transformer with fixed weights that ascertains result feature vectors from the point cloud data as described above. Said data are then fed to the transformation, the result of which are transformed result feature vectors. To obtain the ground truth, an estimation of the box parameters is applied to both the ascertained result feature vectors and the transformed result feature vectors. All box parameters apart from the position differences should remain unchanged. Lastly, the transformed result feature vectors are adapted until the position differences of the box parameters relative to the new anchor position are zero after the transformation and thus lie on top of one another.

The computer program is configured to carry out each step of the method, in particular when it is carried out on a computing device or control unit. It enables the implementation of the method in a conventional electronic control unit without having to make any structural changes. For implementation, the computer program is stored on the machine-readable storage medium.

Installing the computer program in a conventional electronic control unit provides the electronic control unit which is configured to carry out a detection of multiple objects from point cloud data.

### BRIEF DESCRIPTION OF THE DRAWINGS

Embodiment examples of the invention are shown in the drawings and explained in more detail in the following description.

FIG. 1 shows a visualization from a bird's eye view of the ascertainment of the bounding boxes according to the prior art (FIG. 1 a) and according to one embodiment of the method according to the invention (FIG. 1 b).

FIG. 2 shows a flowchart of an embodiment of the method according to the invention.

FIG. 3 shows a flowchart of a transformation of the result feature vectors with respect to the adapted anchor positions according to the method according to the invention.

### EMBODIMENT EXAMPLES OF THE INVENTION

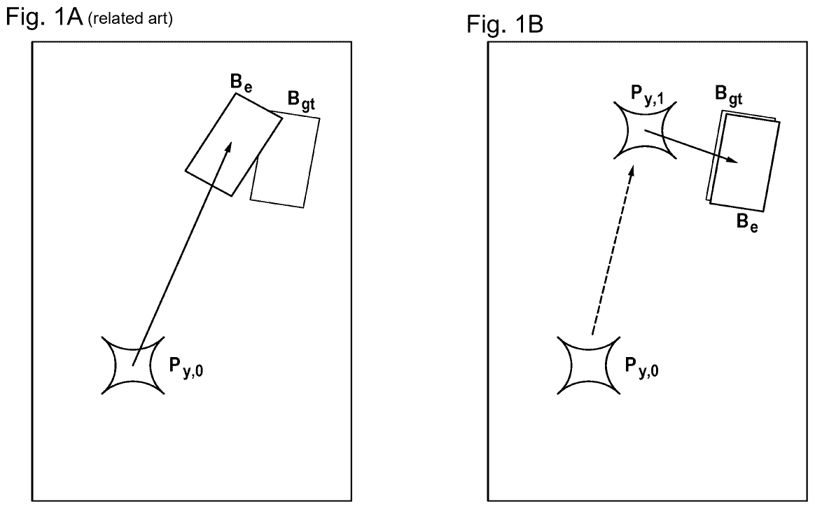

FIG. 1 shows a bird's eye view of a bounding box B_{gt} according to the ground truth and an estimated bounding box Bₑ ascertained by a method for detecting objects using a transformer, as well as the positions P_{y, 0}, P_{y,1} of the object query from which the ascertainment respectively takes place. In FIG. 1 a, the estimated bounding box Bₑ is always ascertained starting from the same position P_{y,0} of the object query. Due to the distance between the position P_{y,0} of the object query and the position of the object, i.e. the position at which the bounding box B_{gt} according to the ground truth is located, inaccuracies occur during the ascertainment in the decoder of the transformer, so that the estimated bounding box Bₑ and the bounding box B_{gt} according to the ground truth are spaced apart significantly. FIG. 1 b shows the result of the method according to the invention. The estimated bounding box Bₑ is ascertained in a first layer of the transformer as in FIG. 1 a starting from the original position P_{y,0} of the object query and is not shown in FIG. 1 b. As described in the following, the object queries are then refined and adapted to new anchor positions that depend on the bounding box Bₑ ascertained in the first layer. The bounding box Bₑ shown here is ascertained in the second layer of the transformer starting from a new position P_{y,1} of the refined object query. This new position P_{y,1} of the refined object query is closer to the actual object, i.e. the position at which the bounding box B_{gt} according to the ground truth is located, so that the estimated bounding box Bₑ can be better determined and the object can thus be detected more accurately.

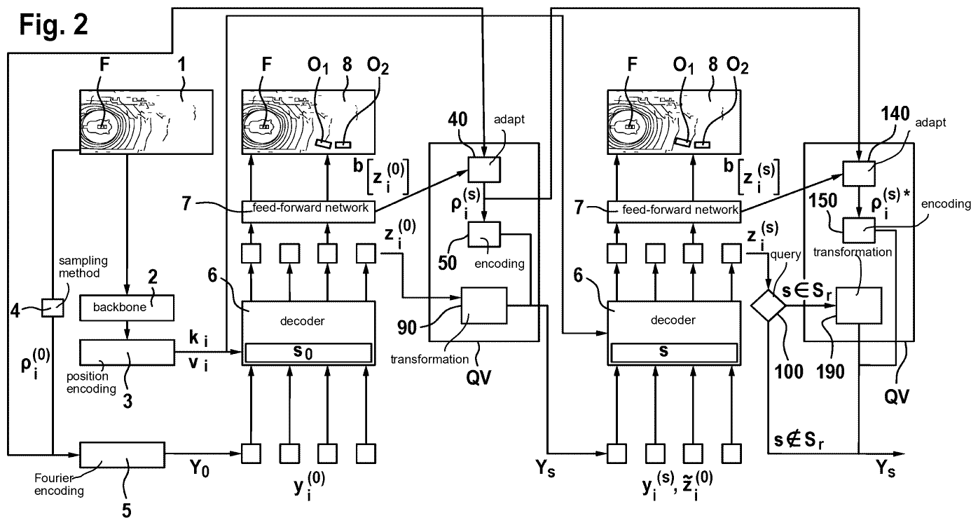

FIG. 2 shows a flowchart of the method according to the invention for two layers of the transformer. The same steps are labeled with the same reference signs and are described only once in detail. In the following, s identifies the number of the layer of the decoder of the transformer. i is used as the running variable of the feature vectors and M feature vectors are provided.

To start, a LiDAR sensor of a vehicle F acquires the surroundings. A visual representation of this recorded point cloud data is labeled 1. From the point cloud data, a backbone 2 calculates feature vectors, which are then augmented by a position encoding 3 using sine and cosine, and ultimately fed as key vectors kᵢ and value vectors νᵢ to a decoder 6 of a transformer.

At the same time, first anchor positions ρᵢ⁽⁰⁾ are ascertained from the point cloud data using a sampling method 4, for example farthest point sampling, and then undergo a Fourier encoding 5:

$${y}_{i}^{( 0 )} = FFN [ sin ( B {ρ}_{i}^{( 0 )} ) , cos ( B {ρ}_{i}^{( 0 )} ) ]$$

B is a matrix comprising entries of the normal distribution; FFN represents a feed-forward network, which consists here of two layers with a ReLU activation (rectified linear unit). γᵢ⁽⁰⁾ are the calculated feature vectors, which are fed as object queries to the decoder 6 of the transformer.

A first set of feature vectors which was ascertained directly from the first anchor positions ρᵢ⁽⁰⁾ is labeled Y₀ and consists of the object queries γᵢ⁽⁰⁾. Each object query γᵢ⁽⁰⁾ serves as a slot (illustrated in FIG. 2 by individual boxes) for a possible object. The decoder 6 of the transformer consists of six layers s, each with eight attention heads. In the first layer s₀ (s=0), the decoder 6 ascertains result feature vectors zᵢ⁽⁰⁾ from the object queries γᵢ⁽⁰⁾ and the key vectors kᵢ and the value vectors νᵢ. The dimension of the object queries γᵢ⁽⁰⁾, the key vectors, kᵢ and the value vectors νᵢ is 256, for example.

This results in the detection of two objects O₁ and O₂. From the result feature vectors zᵢ⁽⁰⁾ of the first layer s₀, a feed-forward network 7 calculates box parameters

$${b}_{[ {z}_{i}^{( 0 )} ]} = ( Δ x , Δ y , Δ z , w , l , h , γ , {v}_{x} , {v}_{y} , cls )$$

for the objects O₁, O₂, wherein Δx, Δy, Δz represents the difference of the position to the anchor positions ρᵢ⁽⁰⁾ in three dimensions, w,l,h are the dimensions of the object O₁, O₂ in three dimensions, γ is the orientation of the object O₁, O₂, νₓ, ν_{y} is the speed of the object O₁, O₂ in the horizontal plane and cls is a class identifier. The objects O₁, O₂ have been detected and are shown here in the visual representation labeled 8.

According to the invention, a refinement VQ of the object queries is carried out. For this purpose, the anchor positions ρᵢ⁽⁰⁾ are adapted 40 to obtain adapted anchor positions ρᵢ^{(s)} for the further layer s of the decoder 6. The position differences Δx, Δy, Δz of the box parameters

$${b}_{[ {z}_{i}^{( 0 )} ]}$$

which were ascertained in the first layer s₀ of the decoder 6, are added to the first anchor positions ρᵢ⁽⁰⁾ as a result of which adapted anchor positions ρᵢ^{(s)} are obtained:

$${ρ}_{i}^{( s )} = ( Δ x , Δ y , Δ z ) + {ρ}_{i}^{( 0 )}$$

Box parameters

$${b}_{[ {z}_{i}^{( 0 )} ]}$$

can be obtained from the result feature vectors zᵢ⁽⁰⁾ that are far away from the first anchor position ρᵢ⁽⁰⁾ and thus have high position differences Δx, Δy, Δz. Adapting 40 the anchor position produces adapted anchor positions ρᵢ^{(s)} that are closer to the object.

Based on these adapted anchor positions ρᵢ^{(s)}, another encoding 50 is carried out, which corresponds to the above encoding 5 to which reference is made. This produces feature vectors that are fed as object queries γᵢ^{(s)} to a further layer s of the decoder 6 of the transformer.

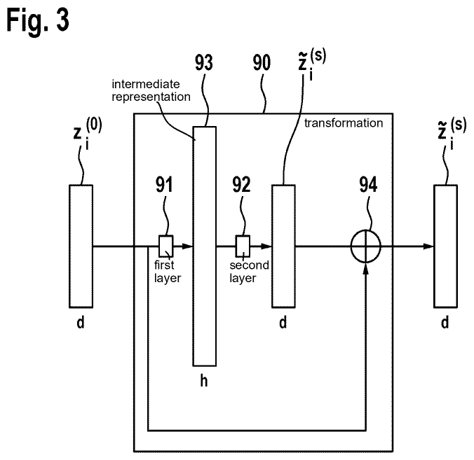

At the same time, an anchor alignment module (AAM) is used to carry out a transformation 90 of the result feature vectors zᵢ⁽⁰⁾ of the first layer so which is described in more detail with reference to FIG. 3. This produces transformed result feature vectors \tilde{z}ᵢ⁽⁰⁾ that are aligned with the adapted anchor positions ρᵢ^{(s)}.

\tilde{z}ᵢ⁽⁰⁾=AAM(zᵢ⁽⁰⁾)

The transformed result feature vectors \tilde{z}ᵢ⁽⁰⁾ and the aforementioned feature vectors γᵢ^{(s)}, which were ascertained using an encoding 50, are fed as a set of feature vectors labeled Yₛ to the further layer s of the decoder.

$${Y}_{s} = {\{ {\tilde{z}}_{i}^{( 0 )} + {y}_{i}^{( s )} \}}_{i = 1}^{M}$$

The sum of each object query γᵢ^{(s)} and each transformed result feature vector \tilde{z}ᵢ⁽⁰⁾ serves as a slot (illustrated in FIG. 2 by individual boxes) for a possible object. This results in a total of M slots. In a further layer s, the decoder 6 ascertains result feature vectors zᵢ^{(s)} from the object queries γᵢ^{(s)} of the current layer s, which were ascertained depending on the adapted anchor positions ρᵢ^{(s)}, the transformed result feature vectors \tilde{z}ᵢ⁽⁰⁾ of the previous layer so as well as the key vectors kᵢ and the value vectors νᵢ as described above. The result feature vectors zᵢ^{(s)} are then likewise fed to a fast forward network 7, which calculates the box parameters

$${b}_{[ {z}_{i}^{( s )} ]} = ( Δ x , Δ y , Δ z , w , l , h , γ , {v}_{x} , {v}_{y} , cls )$$

for the objects O₁, O₂. Due to the refinement VQ of the object queries, the position differences Δx, Δy, Δz ascertained here are small.

FIG. 2 shows a further refinement QV of the object queries for even more layers. In a query 100, a decision is made as to whether a further refinement QV should be carried out, with which a further improvement in the accuracy of the detection in the further layers can be achieved. Sᵣ refers to the layers in which the refinement QV is to be carried out. If s ∉Sᵣ, the result feature vectors zᵢ^{(s)} of the current layer s are used as object queries for a subsequent layer (not shown here).

If s ∈ Sᵣ, an appropriate refinement QV of the object queries is carried out. As described above, on the one hand the anchor positions ρᵢ^{(s)} are adapted 140 to obtain adapted anchor positions ρᵢ^{(s)*} by adding the position differences Δx, Δy, Δz of the box parameters

$${b}_{[ {z}_{i}^{( s )} ]}$$

which were ascertained in the current layer s of the decoder 6, to the anchor positions ρᵢ^{(s)}. Based on these adapted anchor positions ρᵢ^{(s)*}, another encoding 150 is carried out, which corresponds to the above encodings 5 or 50 to which reference is made, as a result of which feature vectors γᵢ^{(s)} are obtained. On the other hand, an anchor alignment module (AAMV) is used to carry out a transformation 190 of the result feature vectors zᵢ^{(s)}, which corresponds to the above transformation 90, which is likewise referred to with reference to FIG. 3, as a result of which transformed result feature vectors \tilde{z}ᵢ^{(s)} are obtained.

The set of feature vectors Yₛ that is fed to a layer s of the decoder 6 can generally be set up depending on the number of the layer and depending on whether a refinement QV of the object queries is carried out for it as follows:

$${Y}_{S} = \{ \begin{matrix}{\{ {\tilde{z}}_{i}^{( s - 1 )} + {y}_{i}^{( s )} \}}_{i = 1}^{M} & for s ∈ {S}_{r} \\ {\{ {z}_{i}^{( s - 1 )} + {y}_{i}^{( j )} \}}_{i = 1}^{M} & for s ∉ {S}_{r} and s \neq 0 \\ {\{ {y}_{i}^{( 0 )} \}}_{i = 1}^{M} & for s = 0\end{matrix}$$

Here j=max{l|l<s∧l∈Sᵣ), which means that in the second case (second line), it is always the current object queries γᵢ^{(j)} obtained by encoding 5, 50, 150 that are fed to the decoder 6. The last line indicates the case for the first layer s₀.

FIG. 3 shows a flowchart of the transformation 90. The result feature vectors zᵢ⁽⁰⁾ are fed to a fast forward network consisting of two layers 91, 92 with ReLU activation. The fast forward network is trained in such a way that the two layers 91, 92 change the result feature vectors zᵢ⁽⁰⁾ such that the position differences Δx, Δy, Δz to the previous anchor position are set to zero. The layers 91, 92 themselves are transformations of the input using learned weights. After the first layer 91, an intermediate representation with the dimension h is obtained. After the second layer 92, the transformed result feature vectors \tilde{z}ᵢ⁽⁰⁾ that have the same dimension d as the input result feature vectors zᵢ⁽⁰⁾ are obtained. A bypass connection 94 to the original result feature vectors zᵢ⁽⁰⁾ is established as well to ensure that no information has been lost. The above description can also be applied to transformations for the further layers s, for example, to the transformation 190.

1.-10. (canceled)

11. A method for detecting multiple objects from point cloud data using a transformer with attention model, wherein a state of the detected objects is stored within the model in a feature space, the method comprising the following steps:
calculating feature vectors from the point cloud data using a backbone, wherein the feature vectors serve as key vectors and value vectors for the transformer;
calculating first anchor positions for a first layer of the transformer from the point cloud data using a sampling method;
ascertaining feature vectors from the first anchor positions using an encoding, wherein the feature vectors serve as object queries for the first layer of the transformer;
ascertaining result feature vectors in the first layer of the transformer from the object queries and the key vectors and the value vectors using the first layer of a decoder of the transformer;
calculating box parameters for the result feature vectors of the first layer of the transformer;
adapting the anchor positions for at least one further layer of the transformer by adding position differences of the box parameters to the first anchor positions;
ascertaining feature vectors from the adapted anchor positions using an encoding, wherein the feature vectors ascertained from the adapted anchor positions serve as object queries for the at least one further layer of the transformer;
transforming the result feature vectors of the first layer with respect to the adapted anchor positions, wherein the transformed result feature vectors serve as object queries for the at least one further layer of the transformer;
ascertaining result feature vectors in the at least one further layer of the transformer from the transformed result feature vectors of the previous layer, the calculated object queries of the current layer, and the key vectors and the value vectors using the decoder of the transformer.

12. The method according to claim 11, wherein, the calculating of the box parameters for the result feature vectors, the adapting of the anchor positions, the ascertaining feature vectors from the adapted anchor positions using an encoding, and the transforming of the result feature vectors with respect to the adapted anchor positions, are carried out for at least one further layer.

13. The method according to claim 11, wherein the following steps are carried out to train the transformer:
estimating multiple sets of box parameters for a decoder output of each layer;
assigning box parameters of the ground truth to closest estimated box parameters;
applying a median regression to a deviation between the box parameters of the ground truth and the associated estimated box parameters;
training the transformer using the median regression.

14. The method according to claim 11, wherein the transformation of the result feature vectors with respect to the adapted anchor positions is implemented by a feed-forward network consisting of two layers with a ReLU activation.

15. The method according to claim 14, wherein the following steps are carried out to train the transformation of the result feature vectors with respect to the adapted anchor positions:
calculating result feature vectors from the point cloud data;
transforming the calculated result feature vectors;
applying an estimate of box parameters for the calculated result feature vectors and the transformed result feature vectors;
adapting the transformed result feature vectors until their position differences of the box parameters are zero.

16. The method according to claim 11, wherein the point cloud data are acquired by LiDAR.

17. The method according to claim 11, wherein the point cloud data are collected from a vehicle.

18. A non-transitory machine-readable storage medium on which is stored a computer program for detecting multiple objects from point cloud data using a transformer with attention model, wherein a state of the detected objects is stored within the model in a feature space, the computer program, when executed by a computer, causing the computer to perform the following steps:
calculating feature vectors from the point cloud data using a backbone, wherein the feature vectors serve as key vectors and value vectors for the transformer;
calculating first anchor positions for a first layer of the transformer from the point cloud data using a sampling method;
ascertaining feature vectors from the first anchor positions using an encoding, wherein the feature vectors serve as object queries for the first layer of the transformer;
ascertaining result feature vectors in the first layer of the transformer from the object queries and the key vectors and the value vectors using the first layer of a decoder of the transformer;
calculating box parameters for the result feature vectors of the first layer of the transformer;
adapting the anchor positions for at least one further layer of the transformer by adding position differences of the box parameters to the first anchor positions;
ascertaining feature vectors from the adapted anchor positions using an encoding, wherein the feature vectors ascertained from the adapted anchor positions serve as object queries for the at least one further layer of the transformer;
transforming the result feature vectors of the first layer with respect to the adapted anchor positions, wherein the transformed result feature vectors serve as object queries for the at least one further layer of the transformer;
ascertaining result feature vectors in the at least one further layer of the transformer from the transformed result feature vectors of the previous layer, the calculated object queries of the current layer, and the key vectors and the value vectors using the decoder of the transformer.

19. An electronic control unit configured to carry out a detection of multiple objects from point cloud data using a transformer with attention model by performing the following steps:
calculating feature vectors from the point cloud data using a backbone, wherein the feature vectors serve as key vectors and value vectors for the transformer;
calculating first anchor positions for a first layer of the transformer from the point cloud data using a sampling method;
ascertaining feature vectors from the first anchor positions using an encoding, wherein the feature vectors serve as object queries for the first layer of the transformer;
ascertaining result feature vectors in the first layer of the transformer from the object queries and the key vectors and the value vectors using the first layer of a decoder of the transformer;
calculating box parameters for the result feature vectors of the first layer of the transformer;
adapting the anchor positions for at least one further layer of the transformer by adding position differences of the box parameters to the first anchor positions;
ascertaining feature vectors from the adapted anchor positions using an encoding, wherein the feature vectors ascertained from the adapted anchor positions serve as object queries for the at least one further layer of the transformer;
transforming the result feature vectors of the first layer with respect to the adapted anchor positions, wherein the transformed result feature vectors serve as object queries for the at least one further layer of the transformer;
ascertaining result feature vectors in the at least one further layer of the transformer from the transformed result feature vectors of the previous layer, the calculated object queries of the current layer, and the key vectors and the value vectors using the decoder of the transformer.
